(19) United States
(12) Patent Application Publication
(10) Pub. No.: US 2017/0045693 A1
(43) Pub. Date: Feb. 16, 2017

(54) MULTI-LAYER FLEXIBLE OPTICAL CIRCUIT

(71) Applicant: Molex, LLC, Lisle, IL (US)

(72) Inventor: Malcolm H. Hodge, Chicago, IL (US)

(73) Assignee: Molex, LLC, Lisle, IL (US)

(21) Appl. No.: 15/304,266

(22) PCT Filed: Apr. 17, 2015
(86) PCT No.: PCT/US2015/026380

§ 371 Date: Oct. 14, 2016

Related U.S. Application Data
(60) Provisional application No. 61/980,802, filed on Apr. 17, 2014.

(51) Int. Cl. G02B 6/36

(52) U.S. Cl. CPC G02B 6/3608; G02B 6/3676

(57) ABSTRACT

A multi-layer optical circuit includes a plurality of stacked flexible substrates and an adhesive between adjacent substrate layers. A plurality of optical fibers are positioned between adjacent substrate layers. The flexible substrates of adjacent substrate layers are secured together by the adhesive and directly engage the plurality of optical fibers between the adjacent substrate layers.

### CROSS-REFERENCE TO RELATED APPLICATIONS

This patent application claims the benefit of U.S. Provisional Patent Application No. 61/980,802, filed Apr. 17, 2014, which is incorporated herein by ret Terence in its entirety.

### TECHNICAL FIELD

This disclosure relates generally to optical fibers and, more particularly, to a multi-layer flexible optical circuit.

### BACKGROUND

Optical fiber circuits are increasingly used to interconnect optical components within electronic and other high speed and/or high bandwidth systems. Optical fibers are sometimes provided in a ribbonized form as an optical fiber cable. In other instances, optical fibers may be mounted on or embedded in one or more substrates to form a multi-layer optical circuit. Optical fiber connectors and other optical components, both active and passive, may be connected to the optical fiber connectors and the multi-layer optical circuits.

One type of optical circuit includes a one or more flexible substrate layers with a plurality of optical fibers secured to the substrate with an adhesive. A conformal coating is applied on top of the substrate, adhesive, and optical fibers to seal and protect the assembly. An additional substrate layer may be secured to the previously formed assembly on top of the conformal coating and additional layers of adhesive, optical fibers, and conformal coatings added to create the desired optical circuit. In one known example, the flexible substrates are about 0.4 mm thick.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY OF THE INVENTION

In a first aspect, a multi-layer optical circuit includes a plurality of stacked flexible substrates with adjacent flexible substrates and an adhesive between adjacent substrate layers. A plurality of optical fibers are positioned between adjacent substrate layers with the optical fibers between adjacent substrate layers defining a first optical fiber group and a second optical fiber group. The flexible substrates of adjacent substrate layers are secured together by the adhesive and directly engage the plurality of optical fibers between the adjacent substrate layers.

In another aspect, a multi-layer optical circuit includes a plurality of stacked flexible substrate layers with an adhesive positioned between adjacent substrate layers. A plurality of optical fibers are positioned between adjacent substrate layers and secured to at least one of the substrate layers by the adhesive with the optical fibers between adjacent substrate layers defining an optical fiber layer. The flexible substrate layers of adjacent adjacent substrate layers directly engage each other except along the plurality of optical fibers.

In still another aspect, a method of fabricating a multi-layer optical circuit includes providing a first flexible substrate with an adhesive thereon, routing a first plurality of optical fibers onto the first flexible substrate to form a first optical fiber layer, providing a second flexible substrate with an adhesive thereon, and directly engaging the first flexible substrate with the second flexible substrate to capture the first plurality of optical fibers between the first flexible substrate and the second flexible substrate. The method further includes routing a second plurality of optical fibers onto the second flexible substrate to form a second optical fiber layer, providing a third flexible substrate, and directly engaging the second flexible substrate with the third flexible substrate to capture the second plurality of optical fibers between the second flexible substrate and the third flexible substrate.

### BRIEF DESCRIPTION OF THE DRAWINGS

FIG. 1 illustrates a plan view of an embodiment of a multi-layer flexible optical circuit;

FIG. 2 illustrates a partially exploded perspective view of the multi-layer flexible optical circuit of FIG. 1;

FIG. 3 illustrates a side view of a diagrammatic illustration of a cross-section through two groups of optical fibers mounted on a substrate at a crossover location during the fabrication process;

FIG. 4 illustrates a diagrammatic illustration of a cross-section through a pair of adjacent substrates at a location with a single group of optical fibers;

FIG. 5 illustrates a diagrammatic illustration of a cross-section through a pair of adjacent substrates at a location without optical fibers;

FIG. 6 illustrates a side view of the diagrammatic illustration of FIG. 3 but after the fabrication process is completed; and

FIG. 7 illustrates a partially exploded perspective view of a second embodiment of a multi-layer flexible optical circuit.

### DETAILED DESCRIPTION

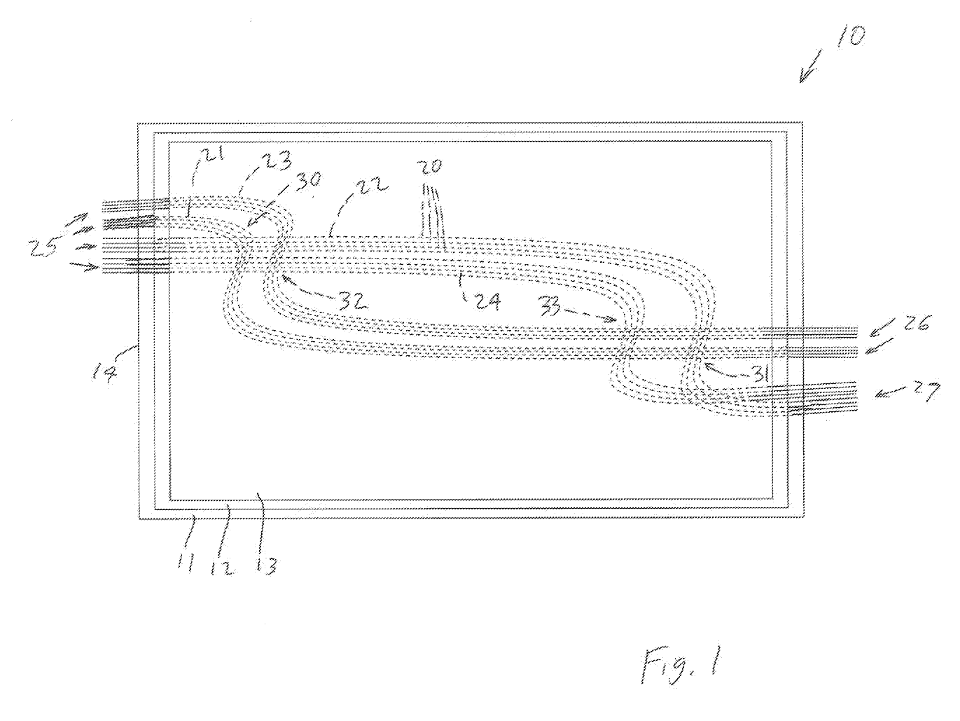

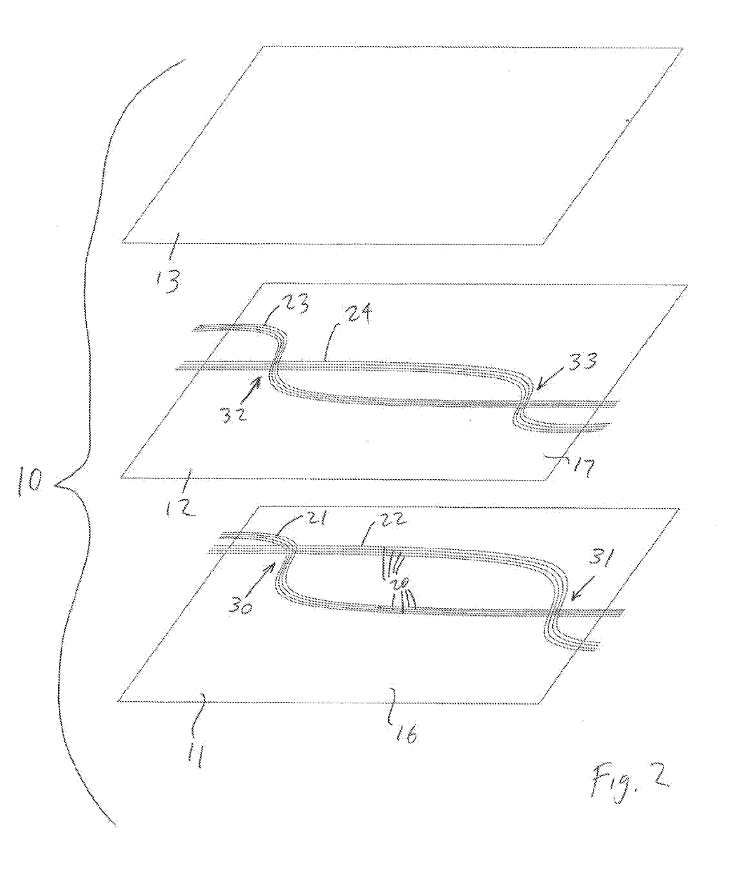

Referring to FIGS. 1-2, a multi-layer flexible optical circuit is generally designated 10. The multi-layer flexible optical circuit 10 includes a lower or base layer substrate 11, an inner layer substrate 12, and an upper or top layer substrate 13. Each of the substrates 11-13 may be formed of a flexible, generally planar, sheet-like material. It should be noted that each of the substrates 11-13 may identically sized but are depicted in FIG. 1 with inner layer substrate 12 being slightly larger than upper layer substrate 13 and slightly smaller than lower layer substrate 11 for clarity. As used herein, “lower,” “upper,” and other similar terms refer to the orientation depicted in the drawings for purposes of this description only. It will be appreciated that the substrates and other components depicted in the drawings may be positioned in any orientation.

In one example, each of the substrates 11-13 may be approximately 0.025 mm thick and made of polyamide or another similar material. Other materials as well as other thicknesses are contemplated. For example, in one embodiment, it is believed that the substrates 11-13 may be no more than 0.075 mm. In another embodiment, it is believed that the substrates 11-13 may be no more than 0.125 mm. In still another embodiment, the substrates 11-13 may be thin enough so that the substrates are less stiff than the optical fibers 20. Multi-layer flexible optical circuit 10 may include more than one inner layer substrates 12, if desired.

Multi-layer flexible optical circuit 10 includes a plurality of optical fibers 20 positioned between adjacent pairs of substrates. More specifically, a plurality of optical fibers 20 may be arranged in a first group 21 and a second group 22 of optical fibers between the base layer substrate Ill and the inner layer substrate 12. Similarly, a third group 23, and a fourth group 24 of optical fibers 20 may be arranged between the inner layer substrate 12 and the top layer substrate 13.

The groups of optical fibers 20 may be arranged in any desired manner and each group may include any number of optical fibers. In addition, the ends of the optical fibers 20 may be configured in any desired manner for interconnection to other components such as optical fiber connectors. As depicted in FIG. 1, multi-layer flexible optical circuit 10 has four groupings 25 of four optical fibers along a first edge 14 of the base layer substrate 11 for interconnection to four optical fiber connectors or other components (not shown). Multi-layer flexible optical circuit 10 includes two groupings 26 of four optical fibers and one grouping 27 of eight optical fibers along a second edge 115 of the base layer substrate for interconnection to four optical fiber connectors or other components (not shown).

The optical fibers 20 may be any type of optical fiber including single mode or multi-mode and formed of silica. In one embodiment, optical fibers 20 have a core and cladding with a combined diameter of approximately 125 μ (microns) and a buffer surrounding the cladding to define a diameter of approximately 250 μ. Other types of optical fibers may be used if desired. In addition, some optical fibers may have other dimensions. In general, the optical fibers 20 are stiffer than the substrates 11-13.

The groups of optical fibers 20 within an optical fiber layer (i.e., between adjacent substrates) may be arranged so that some of the optical fibers cross over other optical fibers within the same layer. Referring to FIG. 2, the second group 22 of optical fibers 20 crosses over the first group 21 of optical fibers at a first crossover location 30 and at a second crossover location 31. Similarly, the fourth group 24 of optical fibers 20 crosses over the third group 23 of optical fibers at a third crossover location 32, and a fourth crossover location 33. It may be seen by referring to FIG. 1 that the crossover locations are offset from each other between optical fiber layers. In other words, while the first crossover location 30 and the third crossover location 32 are generally aligned along the y-axis as viewed in FIG. 1, they are offset from each other along the x-axis. Thus, the first crossover location 30 is closer to the first edge 14 of base layer substrate 11 than the third crossover location 32. Similarly, the second crossover location 31 and the fourth crossover location 33 are aligned along the y-axis but offset along the x-axis so that second crossover location 31 is closer to the second edge 15 of base layer substrate 11 and the fourth crossover location 33.

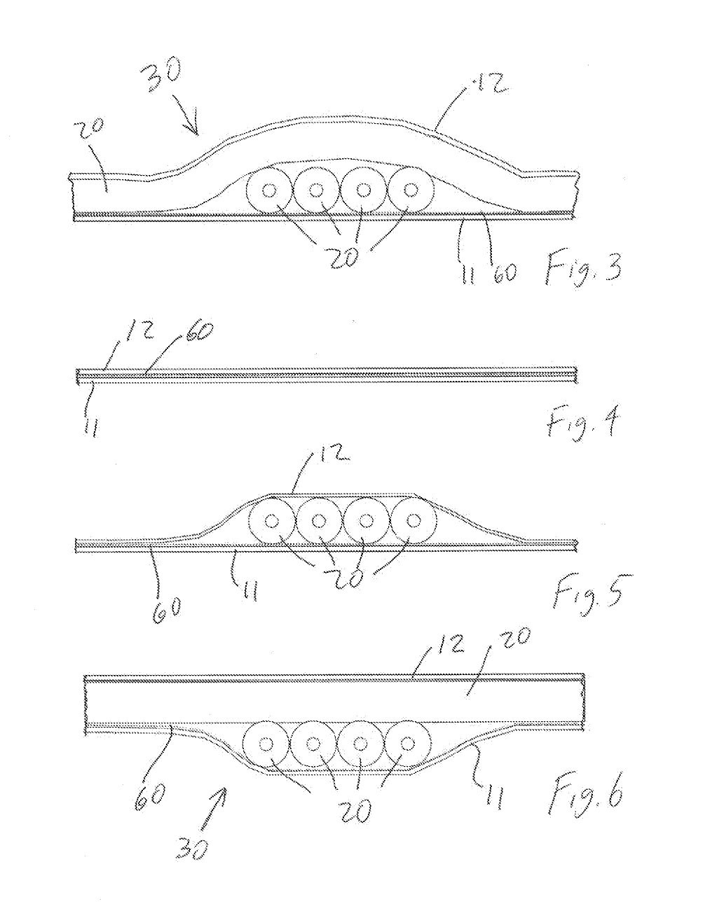

To fabricate multi-layer flexible optical circuit 10, base layer substrate 11 may be secured to a generally planar work surface (not shown) such as a vacuum table. An adhesive 60 (FIG. 3) may be applied to the base layer substrate 11 or the base layer substrate 11 may be provided with an adhesive coating on the upper surface 16 thereof. The adhesive 60 may be any type of adhesive such as, for example, a pressure sensitive adhesive. In one embodiment, the adhesive will not substantially increase the stiffness of the multi-layer flexible optical circuit 10.

A plurality of individual optical fibers 20 are then routed, such as with an automated fiber laying apparatus (not shown) onto the upper surface 16 of the base layer substrate 11 in a desired pattern. In the embodiment depicted in FIGS. 1-2, the optical fibers 20 are routed to form the first group 21 and the second group 22 of optical fibers. In doing so, as described above, the second group 22 of optical fibers crosses over the first group 21 of optical fibers at first crossover location 30 and at second crossover location 31.

Referring to FIG. 3, it may be seen that the optical fibers 20 of the second group 22 are curved as they cross over the optical fibers of the first group 21 at each of the first crossover location 30 and the second crossover location 31. In other words, since the optical fibers 20 of the second group 22 are secured to the base layer substrate 11 (which is secured to the work surface) by the adhesive 60 and then routed over the optical fibers of the first group 21, the optical fibers of the second group bend around the first group of optical fibers.

Referring back to FIG. 2, the inner layer substrate 12 is then applied or pressed. onto the upper surface 16 of the base layer substrate 11 to capture the optical fibers 20 positioned between the base layer substrate and the inner layer substrate. In doing so, the adhesive 60 on the base layer substrate 11 will secure the base layer substrate and the inner layer substrate 12 together and thus secure the optical fibers in their desired locations between the two substrates. Each optical fiber will be secured over a majority of its length to the base layer substrate 11 by the adhesive 60 and captured along its upper surface by the inner layer substrate 12 as may be seen in FIG. 4, With this configuration, the optical fibers 20 of each group of optical fibers will also be held in place by their adjacent optical fibers and the outer optical fibers 20 of each group may also be engaged along one of their side edges by the inner layer substrate 12.

The only optical fibers 20 that will not be engaged by both the base layer substrate 11 and the inner layer substrate 12 are those portions of the optical fibers at the crossover locations as best seen in FIG. 3. At the crossover locations, the upper surface of the second group 22 of optical fibers will be engaged by the lower surface of the inner layer substrate 12 and the lower surface of the first group 21 of optical fibers will be engaged by the adhesive and the upper surface 16 of the base layer substrate 11.

Referring to FIG. 5, at locations in which no optical fibers 20 are present, the lower surface of the inner layer substrate 12 will be directly engaged by the upper surface 16 of the base layer substrate 11.

As used herein, directly engaged and other similar terms refer to two components that are immediately adjacent each other without an intervening component other than adhesive therebetween. For clarity, an optical fiber 20 that is positioned between two substrates with only adhesive between one (FIG. 4) or both of the substrates and the optical fiber is directly engaged by both substrates. Further, two substrates secured together by adhesive 60 as depicted in FIG. 5 are also directly engaged. In FIG. 3, the base layer substrate 11 directly engages the first group 21 of optical fibers 20 at the crossover location and the inner layer substrate 12 directly engages the second group 22 of optical fibers at the crossover location, Two components (e.g., substrates) separated by a conformal coating and an adhesive are not directly engaged. An optical fiber positioned between two substrates with an adhesive securing the optical fiber to a first substrate and a conformal coating separating the adhesive and optical fiber from the second substrate directly engages the first substrate since it is only separated from the substrate by the adhesive but does not directly engage the second substrate.

An adhesive 60 is applied to the upper surface 17 of the inner layer substrate 12 unless utilizing a substrate with the adhesive pre-applied thereon. Individual optical fibers 20 are then routed onto the upper surface 17 of the inner layer substrate 12 in a desired pattern such as to form the third group 23 and the fourth group 24 of optical fibers. The top layer substrate 13 is then applied or pressed onto the upper surface 17 of the inner layer substrate 12 to capture the third group 23 and the fourth group 24 of optical fibers between the inner layer substrate and the top layer substrate.

The substrates 11-13 may be pressed together in any desired manner. Any of a variety of tools may be used for such a pressing operation. In one example, the tool may have a resilient surface for engaging an upper surface of the substrates. In one embodiment, the tool may include a roller that rotates as the tool moves along the upper surface. In another embodiment, the tool may include a generally planar plate. In some instances, it may be desirable to fabricate the entire multi-layer flexible optical circuit 10 by stacking substrates 11-13 and optical fibers 20 together and then using a desired pressing tool to press the substrates together after the entire assembly has been fabricated.

Once the multi-layer flexible optical circuit 10 has been fabricated, the circuit may be released from the work surface. Since the substrates 11-13 are more flexible (i.e., less stiff) than the optical fibers 20, the optical fibers will tend to straighten out at the crossover locations 30-33 while the portions of the substrates 11-13 at the crossover locations will tend to curve around the optical fibers 20. This concept is shown somewhat schematically in FIG. 6 and may be best seen by comparing FIGS. 3 and 6.

Although the optical fiber 20 extending over the first group 21 of optical fibers is depicted as being straight in FIG. 6, the optical fibers 20 at each crossover location may not completely straighten out to the extent depicted in FIG. 6 after completion of the fabrication process. This may be due to the specific pattern of optical fibers 20 located between the substrates 11-13 combined with characteristics of the substrates and the optical fibers. However, in most instances, the bend radius of the optical fibers 20 that cross over other optical fibers within an optical fiber layer will be increased and thus reduce bending losses in the optical fibers.

It should be noted that the cross-sections in FIGS. 4-5 are applicable both during fabrication of the multi-layer flexible optical circuit 10 and after completion of the fabrication process.

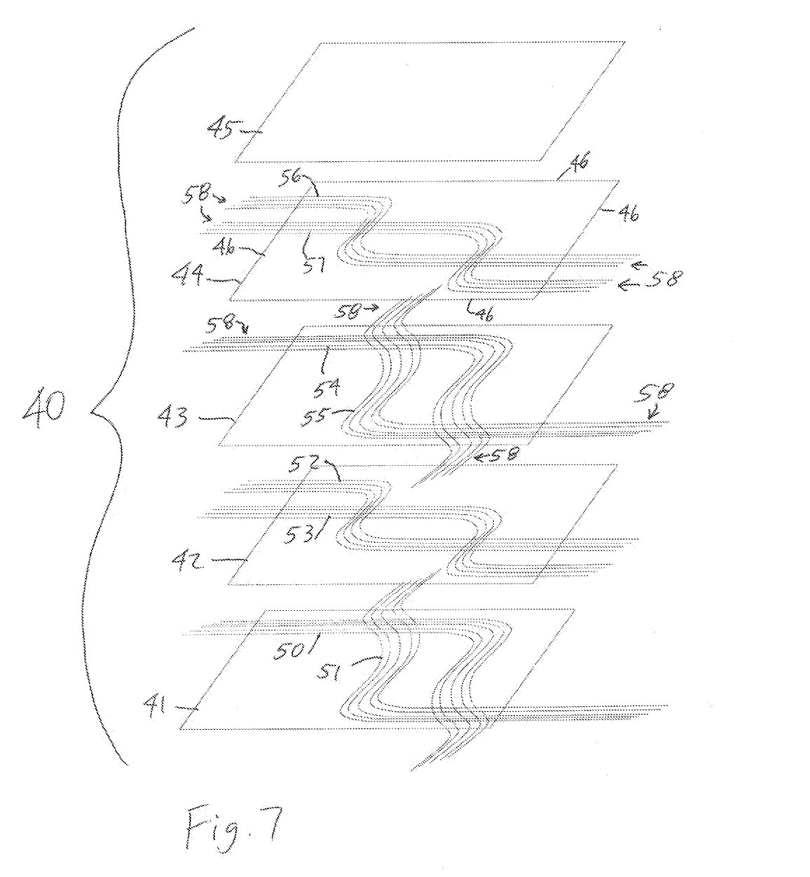

The multi-layer flexible optical circuits may include any desired number of substrates and optical fibers. Referring to FIG. 7, a multi-layer flexible optical circuit 40 is depicted with a base layer substrate 41, a first inner layer substrate 42, a second inner layer substrate 43, a third inner layer substrate 44, and a top layer substrate 45. A first group 50 of optical fibers and a second group 51 of optical fibers are positioned between the base layer substrate 41 and the first inner layer substrate 42. A third group 52 of optical fibers and a fourth group 53 of optical fibers are positioned between the first inner layer substrate 42 and the second inner layer substrate 43. A fifth group 54 of optical fibers and a sixth group 55 of optical fibers are positioned between the second inner layer substrate 43 and the third inner layer substrate 44. A seventh group 56 of optical fibers and an eighth group 57 of optical fibers are positioned between the third inner layer substrate 44 and the top layer substrate 45.

It should be noted that the groups of optical fibers of the multi-layer flexible optical circuit 40 include groupings 58 of optical fibers that extend from all four edges 46 of the substrates 41-45. The multi-layer flexible optical circuit 40 may be assembled or fabricated in a manner identical or similar to that described above with respect to the multi-layer flexible optical circuit 10.

The structure and manner of fabricating the multi-layer flexible optical circuits 10, 40 described herein provide numerous advantages. In one aspect, the radius of curvature of the optical fibers 20 at the crossover locations is substantially reduced since the optical fibers are stiffer than the substrates. As best seen by comparing FIGS. 3 and 6, while the optical fibers 20 are curved to pass over the optical fibers at the crossover locations during the fabrication process, the optical fibers generally straighten out upon completion of the fabrication process. It is desirable to reduce bending in the optical fibers since bends in the optical fibers will reduce the optical performance. In addition, bending of the optical fibers will also generally weaken the optical fibers which will result in a lower life span for the optical fibers. By using substrates 11-13 that are more flexible than the optical fibers 20, the extent to which the optical fibers bend at crossover locations is reduced.

In another aspect, since the substrates 11-13 are extremely flexible, the optical fibers 20 are retained or secured in their desired positions between the substrates by the engagement between adjacent substrates. In other words, the adhesive 60 that secures adjacent substrates together also secures the optical fibers at their desired locations between the substrates. Even though only the lower substrate of each substrate pair may include adhesive thereon, the upper substrate of each pair will be secured directly to directly engage) the lower substrate at all points of the substrate other than at the optical fibers 20. As a result, the optical fibers 20 will be sandwiched between and directly engage the upper and lower substrates of each substrate pair.

In still another aspect, crossover locations may be offset between optical layers to minimize any instances in which the crossover locations are aligned. By offsetting the crossover locations, the overall height of the multi-layer flexible optical circuit 10 may be minimized. For example, offsetting the crossover locations results in minimal increases in the overall height of the multi-layer flexible optical circuit 10 even when adding additional optical circuit layers and substrates.

In prior designs, a conformal coating was typically applied on top of the optical fibers and the adhesive 60 after positioning the optical fibers on top of the substrate with the adhesive thereon to secure the optical fibers at their desired locations on top of the substrate. in other words, in the past, the optical fibers 20 were secured in place by the conformal coating and not by contact with the substrates above and below the optical fibers as is disclosed herein.

Forming the substrates 11-13 from extremely thin and flexible material and removing the necessity of the conformal coating between the substrates creates numerous additional advantages. In an additional aspect, the nature of the substrates and the lack of conformal coating permit light to pass through the multi-layer flexible optical circuit 10, even when fabricated with as many as five to seven inner layer substrates. Certain flaws or defects in the multi-layer flexible optical circuit 10 may result in light being visible through the substrates 11-13. Defective optical fibers may be located by locating the source of the light passing through the multi-layer flexible optical circuit. In addition, one or more defective optical fibers 20 may be replaced by applying an adhesive 60 and replacement optical fibers on the upper surface of the multi-layer flexible optical circuit 10 and aligning the replacement optical fibers with the desired groupings of optical fibers. A new substrate may be applied to the multi-layer flexible optical circuit 10 on top of the replacement optical fibers and secured in place. Due to the thin and flexible nature of the substrates and the optical fibers, adding an additional substrate and the replacement optical fibers will not substantially increase the thickness of the multi-layer flexible optical circuit nor substantially reduce its flexibility.

In yet another aspect, due to the extremely thin and flexible nature of the substrates and the lack of conformal coatings between substrates, the multi-layer flexible optical circuit 10 will remain extremely flexible. As a result, constraints on bending the multi-layer flexible optical circuit 10 will generally be consistent with constraints on bending optical fibers in general. Still further, the absence of the conformal coating also permits faster processing of the multi-layer flexible optical circuits 10 since the conformal coating typically requires a lengthy curing process. In addition, since the multi-layer flexible optical circuit 10 does not include a conformal coating that needs to be cured, the multi-layer flexible optical circuit does not need to be moved from the fiber laying equipment to a curing station and thus avoids a complicated and time-consuming registration process each time the partially formed assembly is moved from the curing station back to the fiber laying station.

Other configurations of multi-layer flexible optical circuits are contemplated. For example, in some embodiments, the base layer substrate 11 may be thicker than the other substrates. Increasing the thickness of the base layer substrate 11 may increase the overall thickness of the multi-layer flexible optical circuit and reduce the overall flexibility of the circuit. However, the multi-layer flexible optical circuit 10 would still eliminate the need for using a conformal coating on top of each substrate, adhesive, and optical circuit layer, and thus reduce the complexity, cost, and processing time of the circuit assembly.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise dearly contradicted by context.

1. A multi-layer optical circuit comprising:
a plurality of stacked flexible substrates layers;
an adhesive between adjacent substrate layers; and
a plurality of optical fibers positioned between adjacent substrate layers, the optical fibers between adjacent substrate layers defining a first optical fiber group and a second optical fiber group, wherein the adjacent substrate layers are secured together by the adhesive and directly engage the plurality of optical fibers between the adjacent substrate layers,

2. The multi-layer optical circuit of claim I, wherein the adjacent substrate layers are directly engaged.

3. The multi-layer optical circuit of claim 3, wherein at least one of the optical fibers of the first optical fiber group crosses over a plurality of optical fibers of the second optical fiber group at a crossover location.

4. The multi-layer optical circuit of claim 1, wherein the crossover locations between adjacent substrate layers are offset to reduce a height of the multi-layer optical circuit.

5. The multi-layer optical circuit of claim 1, wherein each of the plurality of optical fibers has a length and the plurality of optical fibers over substantially their entire length directly engage the flexible substrates of their respective adjacent substrate layers.

6. The multi-layer optical circuit of claim 5, wherein the plurality of optical fibers over their entire length other than at crossover locations directly engage the flexible substrates of their respective adjacent substrate layers.

7. The multi-layer optical circuit of claim 6, wherein the crossover locations include at least one lower optical fiber and at least one upper optical fiber, and a lower substrate layer of adjacent substrate layers directly engages the at least one lower optical fiber at the crossover location and an upper substrate layer of adjacent substrate layers directly engages the at least one upper optical fiber at the crossover location.

8. The multi-layer optical circuit of claim 1, wherein the plurality of optical fibers are secured between adjacent substrate layers without a conformal coating between the flexible substrates.

9. The multi-layer optical circuit of claim 1, wherein the optical fibers have a diameter and the flexible substrates have a thickness, the thickness being less than 50% of the diameter.

10. The multi-layer optical circuit of claim 1, wherein the optical fibers have a diameter and the flexible substrates have a thickness, the thickness being less than 30% of the diameter.

11. The multi-layer optical circuit of claim 1, wherein each flexible substrate is approximately 0.025 mm thick.

12. A multi-layer optical circuit comprising:
a plurality of stacked flexible substrate layers;
an adhesive positioned between adjacent substrate layers; and
a plurality of optical fibers positioned between adjacent substrate layers and secured to at least one of the substrate layers by the adhesive, the optical fibers between adjacent substrate layers defining an optical fiber layer, wherein the flexible substrate layers of adjacent substrate layers directly engage each other except along the plurality of optical fibers.

13. The multi-layer optical circuit of claim 12, wherein a first optical fiber of a first optical fiber layer crosses over a second optical fiber within the first optical fiber layer at a first crossover location.

14. The multi-layer optical circuit of claim 13, wherein a first optical fiber of a second optical fiber layer crosses over a second optical fiber within the second optical fiber layer at a second crossover location, the first crossover location and the second crossover location being offset to reduce a height of the multi-layer optical circuit.

15. The multi-layer optical circuit of claim 12, wherein each of the plurality of optical fibers has a length and the plurality of optical fibers over substantially their entire length directly engage the flexible substrate layers of their respective adjacent substrate layers.

16. The multi-layer optical circuit of claim 15, wherein the plurality of optical fibers over their entire length other than at crossover locations directly engage the flexible substrate layers of their respective adjacent substrate layers.

17. The multi-layer optical circuit of claim 16, herein the crossover locations include at least one lower optical fiber and at least one upper optical fiber, and a lower substrate layer of adjacent substrate layers directly engages the at least one lower optical fl at the crossover location and an upper substrate layer of adjacent substrate layers directly engages the at least one upper optical fiber at the crossover location.

18. The multi-layer optical circuit of claim 12 wherein the plurality of optical fibers are secured between adjacent substrate layers without a conformal coating between the flexible substrate layers.

19. A method of fabricating a multi-layer optical circuit comprising:
providing a first flexible substrate with an adhesive thereon;
routing a first plurality of optical fibers onto the first flexible substrate to form a first optical fiber layer;
providing a second flexible substrate;
providing an adhesive on one of the first and second flexible substrates;
directly engaging the first flexible substrate with the second flexible substrate to capture the first plurality of optical fibers between the first flexible substrate and the second flexible substrate;
routing a second plurality of optical fibers onto the second flexible substrate to form a second optical fiber layer;
providing a third flexible substrate; and
directly engaging the second flexible substrate with the third flexible substrate to capture the second plurality of optical fibers between the second flexible substrate and the third flexible substrate.

20. The method of claim 19, further including securing the first flexible substrate to a work surface before routing the first plurality of optical fibers, the routing step includes laying a first optical fiber of the first optical fiber layer in an arcuate manner over a second optical fiber within the first optical fiber layer at a first crossover location to define a crossover curve, and releasing the first flexible substrate from the work surface and permitting the first optical fiber to straighten from the crossover curve.
